(19) United States
(12) Patent Application Publication
(10) Pub. No.: US 2007/0299936 A1
(43) Pub. Date: Dec. 27, 2007

(54) INTERACTIVELY STREAMING DATA FROM A DATABASE IN A HIGH SPEED, LOW LATENCY DATA COMMUNICATIONS ENVIRONMENT

(76) Inventors: KENNETH W. BORGENDALE, Austin, TX (US); Donald E. Payne, Huntington, NY (US); Scott M. Preddy, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/426,764

(22) Filed: Jun. 27, 2006

(51) Int. Cl. G06F 15/16

(52) U.S. Cl. 709/219

(57) ABSTRACT

Methods, apparatus, and products arc disclosed for interactively streaming data from a database in a high speed, low latency data communications environment that include receiving, in a stream administration server from a subscribing client device, a request for a message stream of historical data from a database; brokering, by the stream administration server, establishment of the message stream from a database feed adapter to the subscribing client device; retrieving, by the database feed adapter, the historical data from the database; converting, by the database feed adapter, the historical data from a database format to a streaming message format; and transmitting, by the database feed adapter, the historical data in the streaming message format to the subscribing client device on the message stream.

### BACKGROUND OF THE INVENTION

1. Field of the Invention

The field of the invention is data processing, or, more specifically, methods, systems, and products for interactively streaming data from a database in a high speed, low latency data communications environment.

2. Description Of Related Art

Messaging environments are generally available to provide data communication between message sending devices and message receiving devices using application messages. An application message is a quantity of data that includes one or more data fields and is passed from a message producer installed on a message sending device to a message consumer installed on a message receiving device. An application message is a form of message recognized by application software operating in the application layer of a data communication protocol stack—as contrasted for example with a transport message or network message, which are forms of messages recognized in the transport layer and the network layer respectively. An application message may represent, for example, numeric or textual information, images, encrypted information, and computer program instructions.

A messaging environment may support point-to-point messaging, publish and subscribe messaging, or both. In a point-to-point messaging environment, a message producer may address an application message to a single message consumer. In a publish and subscribe messaging environment, a message producer may publish an application message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message sending device (100), a message receiving device (104), a message administration server (102), and a database (116). The message sending device (100) is a computer device having installed upon it a message producer (1 10), a set of computer program instructions configured for creating and transmitting application messages to the message administration server (102) for delivery to a message receiving device. In the example of FIG. 1, the message producer (110) may create the application messages from information stored in a database (116). The message producer (110) of FIG. 1 transmits application messages to the message administration server (102) on a message stream (106). The message sending device (100) may produce the transmitted messages by generating the application messages from data of the message sending device itself or data received from some other source. The message receiving device (104) is a computer device having installed upon it a message consumer (112), a set of computer program instructions configured for receiving application messages from the message administration server (102). In the example of FIG. 1, the message consumer (112) receives the application messages from the message administration server (102) on a message stream (108). In the example of FIG. 1, the message stream (106) and the message stream (108) are data communication channels implemented using, for example, the User Datagram Protocol (‘UDP’) and the Internet Protocol (‘IP’).

In either a point-to-point messaging environment or a publish and subscribe messaging environment, the application messages transmitted from message sending devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSpher® MQ, the Open Message Queue from Sun Microsystems, and the OpenJMS from The OpenJMS Group. In a point-to-point messaging environment, the message administration module (114) provides message queuing for the message consumer (112) as the message administration module (114) receives application messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send. Moreover, the message administration module (114) may also coordinate providing to the message consumer backup messages from a backup message producer in the event that a failure occurs on the message producer (110).

Current messaging environments such as, for example, the one described above with reference to FIG. 1, have certain drawbacks. Application messages transmitted to a message administration server from a message sending device for delivery to a message receiving device are delayed in the message administration server until the message administration server can process the messages. The message processing that occurs in the message administration server increases the overall messaging latency of the messaging environment and decreases the overall speed for transmitting data in the data communications environment. Messaging latency is the time period beginning when the message producer transmits an application message and ending when the message consumer receives the application message.

In many data communication environments, even slight increases in messaging latency are costly. Consider, for example, a financial market data environment. A financial market data environment is a data processing environment used to communicate information about financial markets and participants in financial markets. In a financial market data environment, an application message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message sending devices send application messages directly to message receiving devices. The drawback to such current solutions is that removing the message administration server removes the administration functionality provided by the message administration server from the messaging environment. Current solutions, therefore, effectively offer no solution in messaging environments where the administrative functions of a message administration server are required. Consider again the financial market data environment example from above. In such an exemplary financial market data environment, consider that a message receiving device is only authorized to receive financial quotes on certain financial securities. Removing the message administration server from such a financial market data environment removes the ability to administer the messages received by the message receiving device from the message sending device in the financial market data environment.

In current messaging environments in which some of the application messages are generated from information stored in a database, current solutions allow message receiving devices to access the information directly from the database and allow the database to perform the administrative functionality typically provided by the message administration server. The drawback to such a current solution is that the message receiving device must be configured to utilize more than one interface—one interface for receiving messages from the message administration server and another interface for retrieving information from the database. Because the messages from the message administration server and the information from the database typically utilize different data formats, the message receiving device must also be configured to manipulate the data in two formats or convert data from one format to another. Configuring messages receiving devices to perform these additional tasks increases the cost and complexity of the message receiving devices. An additional drawback is that the administrative functionality provided by the message administration server Is duplicated in the database. Duplicating the administrative functionality in both the message administration server and the database is often an inefficient use of computing and financial resources.

### SUMMARY OF THE INVENTION

Methods, apparatus, and products are disclosed for interactively streaming data from a database in a high speed, low latency data communications environment that include receiving, in a stream administration server from a subscribing client device, a request for a message stream of historical data from a database; brokering, by the stream administration server, establishment of the message stream from a database feed adapter to the subscribing client device; retrieving, by the database feed adapter, the historical data from the database; converting, by the database feed adapter, the historical data from a database format to a streaming message format; and transmitting, by the database feed adapter, the historical data in the streaming message format to the subscribing client device on the message stream.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

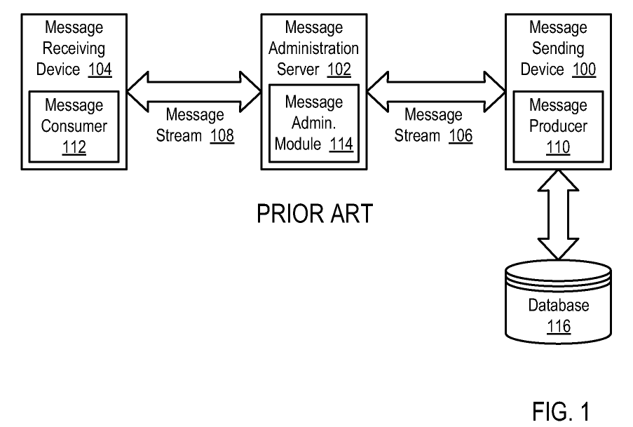

FIG. 2 sets forth a network and block diagram illustrating an exemplary computer data processing system for interactively streaming data from a database in a high speed, low latency data communications environment according to embodiments of the present invention.

FIG. 3 sets forth a block diagram of automated computing machinery comprising an example of a database feed adapter useful in interactively streaming data from a database in a high speed, low latency data communications environment according to embodiments of the present invention.

FIG. 4 sets forth a flow chart illustrating an exemplary method for interactively streaming data from a database in a high speed, low latency data communications environment according to embodiments of the present invention.

FIG. 5 sets forth a flow chart illustrating a further exemplary method for interactively streaming data from a database in a high speed, low latency data communications environment according to embodiments of the present invention.

FIG. 6 sets forth a flow chart illustrating a further exemplary method for interactively streaming data from a database in a high speed, low latency data communications environment according to embodiments of the present invention.

### DETAILED DESCRIPTION OF EXEMPLARY EMBODIMENTS

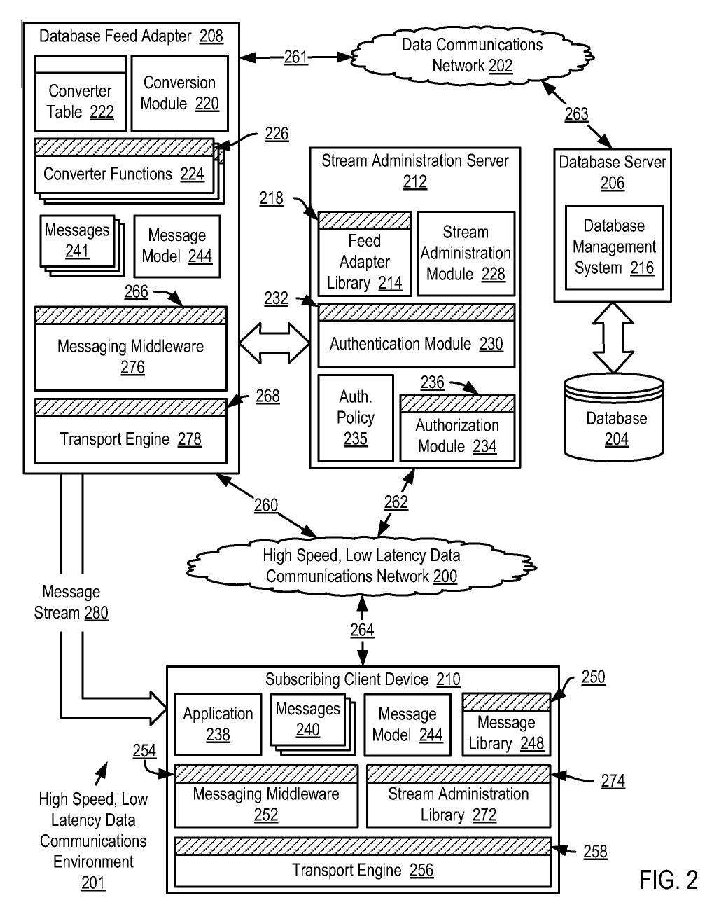

Exemplary methods, apparatus, and products for interactively streaming data from a database in a high speed, low latency data communications environment according to embodiments of the present invention are described with reference to the accompanying drawings, beginning with FIG. 2. FIG. 2 sets forth a network and block diagram illustrating an exemplary computer data processing system for interactively streaming data from a database (204) in a high speed, low latency data communications environment (201 ) according to embodiments of the present invention. The system of FIG. 2 operates generally for interactively streaming data from a database (204) in a high speed, low latency data communications environment (201) according to embodiments of the present invention as follows: A stream administration server (212) receives, from a subscribing client device (21 0), a request for a message stream (280) of historical data from a database (204). The stream administration server (212) brokers establishment of the message stream (280) from a database feed adapter (208) to the subscribing client device (210). The database feed adapter (208) retrieves the historical data from the database (204) and converts the historical data from a database format to a streaming message format. The database feed adapter (208) transmits the historical data in the streaming message format to the subscribing client device (210) on the message stream (280).

The high speed, low latency data communications environment (201) illustrated in FIG. 2 includes a high speed, low latency data communications network (200). The network (200) includes a database feed adapter (208), a stream administration server (212), and a subscribing client device (210), as well as the infrastructure for connecting such devices (208, 212, 210) together for data communications. The network (200) of FIG. 2 is termed ‘high speed, low latency’ because the application messages sent between devices connected to the network (200) on message streams administered by the stream administration server (212) bypass the stream administration server (212). For example, the application messages on the message stream (280) from the database feed adapter (208) to the subscribing client device (210) bypass the stream administration server (212). Although such messages are not delayed for processing in the stream administration server (212), the stream administration server (212) retains administration of the streams between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in interactively streaming data from a database in a high speed, low latency data communications environment according to embodiments of the present invention may include a router.

As mentioned above, the high speed, low latency data communications environment (201) depicted in FIG. 2 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), a feed adapter library (214), an authentication module (230), an authorization module (234), and an authorization policy (235). A stream administration module (228) is a set of computer program instructions configured for interactively streaming data from a database in a high speed, low latency data communications environment according to embodiments of the present invention. The stream administration module (228) of FIG. 2 operates generally for interactively streaming data from a database in a high speed, low latency data communications environment according to embodiments of the present invention by receiving, in a stream administration server from a subscribing client device, a request for a message stream of historical data from a database and brokering establishment of the message stream (280) from a database feed adapter (208) to the subscribing client device (210). The stream administration module (228) of FIG. 2 also operates generally for interactively streaming data from a database in a high speed, low latency data communications environment according to embodiments of the present invention by establishing a transmission rate threshold in the database feed adapter.

The communications between the stream administration module (228) and the feed adapter (208) may be implemented using a feed adapter library (214). The feed adapter library (214) is a set of functions contained in dynamically linked libraries or statically linked libraries available to the stream administration module (228) through a feed adapter library API (218). Through the feed adapter library (214), the stream administration module (228) of the stream administration server (212) may administer the database feed adapter (208), including providing to the database feed adapter (208) the request for a message stream of historical data received from a subscribing client device and establishing in the database feed adapter (208) a transmission rate threshold. Functions of the feed adapter library (214) used by the stream administration module (228) may communicate with the database feed adapter (208) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL arc compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java RMI allows a Java client to access a remote Java object just like any other local Java object.

In addition to administering the database feed adapter (208), the stream administration module (228) administers the message streams by providing security services such as, for example, authenticating the subscribing client device (210) and authorizing the subscribing client device (210) to receive application messages from the database feed adapter (208) on the message stream (280). The authentication module (230) of FIG. 2 is a set of computer program instructions capable of providing authentication security services to the stream administration module (228) through an exposed authentication application programming interface (‘API’) (232). Authentication is a process verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message stream (280). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 2, database feed adapter (208) is connected to the high speed, low latency data communications network (200) through a wireline connection (260). The database feed adapter (208) of FIG. 2 is a computer device having the capabilities of retrieving historical data from a database, converting the historical data from a database format to a streaming message format and transmitting the historical data in a streaming message format to a subscribing client device on a message stream. In the example of FIG. 2, the database feed adapter has installed upon it a conversion module (220), a converter table (222), converter functions (224), application messages (241), message model (244), messaging middleware (276), and a transport engine (278).

The conversion module (220) of FIG. 2 is a set of computer program instructions configured for interactively streaming data from a database in a high speed, low latency data communications environment according to embodiments of the present invention. The conversion module (220) of FIG. 2 operates generally for interactively streaming data from a database in a high speed, low latency data communications environment according to embodiments of the present invention by retrieving historical data from the database (204); converting the historical data from a database format to a streaming message format; and transmitting the historical data in the streaming message format to the subscribing client device (210) on the message stream (280).

The conversion module (220) of FIG. 2 converts the historical data from a database format to a streaming message format using a converter table (222). The converter table (222) of FIG. 2 is a table that includes references to converter functions (224) capable of converting data from one format to another format. Utilizing multiple converter tables, the conversion module (220) may convert data from a variety of input formats to a variety of output formats. In the example of FIG. 2, converter table (222) specifies the converter functions (224) capable of converting historical data from a database format to a streaming message format. In addition, the converter table (222) of FIG. 2 includes references to converter functions (224) capable of converting request parameters of a request for a message stream of historical data from a subscribing client device into a database query. The converter table (222) of FIG. 2 may be implemented using a structured document such as, for example, an eXtensible Markup Language (‘XML’) document.

The converter functions (224) of FIG. 2 are functions capable of converting data fields of a data structure from one format to another format or converting values of data fields from one value to another value. Converter functions (224) may, for example, convert a 16-it integer to a 32-bit integer, convert a number stored in a string field to a 64-bit double floating point value, increase the value of a particular data field by one, or any other conversion as will occur to those of skill in the art. The conversion module (220) accesses the converter functions (224) through a set of converter function APIs (226) exposed by the converter functions (224). Moreover, the converter functions (224) of FIG. 2 are capable of converting request parameters of a request for a message stream of historical data from a subscribing client device into a database query.

In the example of FIG. 2, conversion module (220) uses the converter functions (224) to convert the historical data from a database format to a streaming message format. The application messages (241) of FIG. 2 represent the historical data having streaming message format for transmission to the subscribing client device (210). The streaming message format of the messages (241) is specified in the message model (244). The message model (244) is metadata that defines the structure and the format of the messages (241). The message model (244) may be attached to and transmitted along with the application messages (240) to the subscribing client device (210). More often, however, both the subscribing client device (210) and the feed adapter (208) may receive the message model (244) from the stream administration server (212) when the stream administration server (212) brokers the message stream (280). A message model may be implemented using a structured document, such as, for example, an XML document, a Java object, C++ object, or any other implementation as will occur to those of skill in the art.

Before the conversion module (220) of FIG. 2 performs data processing on the source stream messages, the conversion module (220) receives the source stream messages from the feed source (213). The conversion module (220) of FIG. 2 may receive the source stream messages through a receiving transport engine (not shown) of the active feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received source stream messages directly to the conversion module (220) or to the messaging middleware (276), which in turn, provides the source stream messages to the conversion module.

The messaging middleware (276) of FIG. 2 is a software component that provides high availability services between the database feed adapter (208) and the subscribing client device (210) as well as providing synchronization services between the database feed adapter (208) and any redundant backup database feed adapters. Messaging middleware (276) of FIG. 2 may provide synchronization services through a data communications channel between the database feed adapter (208) and any redundant backup database feed adapters. After the conversion module (220) of FIG. 2 performs data processing on the application messages, the messaging middleware (276) receives the application messages (241) from the conversion module (220) and provides the received application messages to the transport engine (278) for transmission to a subscribing client device on the message stream (280). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) includes a set of computer program instructions capable of encapsulating the application messages (241) provided by the messaging middleware (276) into packets and transmitting the packets through the message stream (280) to the subscribing client device (210). The messaging middleware (276) operates the transport engine (278) through a transport API (268) exposed by the transport engine (278).

In the example of FIG. 2, the database feed adapter (208) retrieves data from a database (204). A database is a collection of related data and metadata. In the example of FIG. 2, the database (204) is a collection of historical data, such as, for example, historical application message data, and related metadata. Metadata is data that describes other data such as, for example, data statistics. The data of a database is typically grouped into related structures called ‘tables,’ which in turn are organized in rows of individual data elements. The rows are often referred to a ‘records,’ and the individual data elements are referred to as ‘fields’ or ‘columns.’ In this specification generally an aggregation of records is referred to as a ‘table.’

The metadata of a database typically includes schemas, table indexes, and database statistics. A schema is a structural description of the data in the database. A schema typically defines the columns of a table, the data types of the data contained in each column, which columns to include in an index, and so on. An index is a database structure used to optimize access to the rows in a table An index is typically smaller than a table because an index is created using one or more columns of the table, and an index is optimized for quick searching, usually via a balanced tree. Database statistics describe the data in tables of a database. Database statistics may describe, for example, the number of records having a particular value for a particular field. As with the data of a database, metadata is often stored in tables of the database.

The database (204) of FIG. 2 may be implemented as an application message history database that stores historical data implemented as historical application message data. Examples of historical application message data may include ticks generated in a financial market data environment by a tick source such as the Options Price Reporting Authority (‘OPRA’). OPRA is the securities information processor for financial market information generated by the trading of securities options in the United States. The core information that OPRA disseminates is last sale reports and quotations. Other examples of tick sources in financial market data environment may include the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center^{SM} which is an electronic screen-based equity securities market in the United States.

The data stored in the database (204) of FIG. 2 is accessed through a database server (206) connected to a data communications network (202). The database server (206) has installed upon it a database management system (‘DBMS’) (216). The DBMS (216) is computer software that supports access to information in a database by helping other computer programs access, manipulate, and save information in the database (204). The DBMS (216) of FIG. 2 supports access and management tools to aid users, developers, and other computer programs in accessing information in a database. One such access and management tool is the structured query language (‘SQL’). SQL is query language for requesting information from a database. Although there is a standard of the American National Standards Institute (‘ANSI’) for SQL, as a practical matter, most versions of SQL tend to include many extensions. In the example of FIG. 2, the database feed adapter (208) connects to the data communications network (202) through a wireline connection (261) to retrieve historical data from the database (204). The connection between the database feed adapter (208) and the database server (206) may be implemented according to the Java Database Connectivity (‘JDBC’) or the Open Database Connectivity (‘ODBC’) standards.

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 2, the subscribing client device (210) is a computer device having installed upon it an application (238), a message library (248), messaging middleware (252), a stream administration library (272), and a transport engine (256). The application (238) of FIG. 2 is a software component that processes data contained in the application messages (240) received from the database feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks stored by the database (204). The subscribing client device may then transmit the ticks to a feed adapter for resale to other subscribing client devices.

In the example of FIG. 2, the application messages (240) represent historical data having a streaming message format received from the database feed adapter (208). The application (238) of FIG. 2 processes the historical data contained in the application messages (240) using the message library (248). The message library (248) is a set of functions that are computer program instructions for creating, accessing, and manipulating messages (240) according to the message model (244). The message library (248) is accessible to the application (238) through a message API (250) exposed by the message library (248). The streaming message format of the application messages (240) is specified in the message model (244).

The communications between the subscribing client device (210) and the stream administration server (212) may be implemented using a stream administration library (272). The stream administration library (272) of FIG. 2 is a set of functions contained in dynamically linked libraries or statically linked libraries available to the application (238) through a stream administration library API (274). Through the stream administration library (272), the application (238) of the subscribing client device (210) may request for a message stream of historical data from a database, request to subscribe to messages from a source other than the database (204), modify an existing message subscription, or cancel a message subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

Before the application (238) processes the data contained in the messages (240), the application (238) receives the messages (240) from the messaging middleware (252), which, in turn, receives the application messages (240) from one of the feed adapter (208, 206) through the transport engine (256). The messaging middleware (252) is a software component that provides high availability services between the subscribing client device, the feed adapter (208), and the backup feed adapter (206). In addition, the messaging middleware (252) provides message administration services for the stream administration server (212). Such message administration services may include restricting the ability of the application (238) to send and receive messages on a message stream to messages that satisfy certain constraints. The application (238) and the stream administration library (272) interact with the messaging middleware (252) through a messaging middleware API (254).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) includes a set of computer program instructions capable of receiving packets through the message stream (280) from the database feed adapter (208), unencapsulating the application messages from the received packets, and providing the application messages to the messaging middleware (252). The messaging middleware (252) operates the transport engine (256) through a transport API (258) exposed by the transport engine (256).

The servers and other devices illustrated in the exemplary system of FIG. 2 are for explanation, not for limitation. Devices useful in interactively streaming data from a database in a high speed, low latency data communications environment according to embodiments of the present invention may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

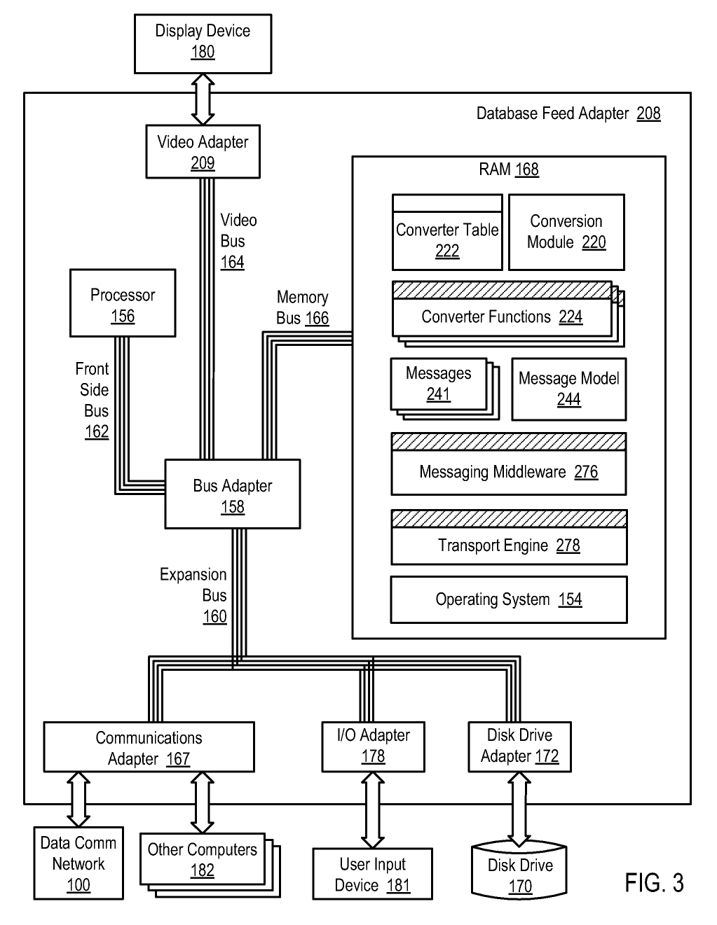

Interactively streaming data from a database in a high speed, low latency data communications environment in accordance with the present invention in some embodiments may be implemented with one or more subscribing client devices, stream administration servers, and database feed adapters, computers, that is, automated computing machinery. For further explanation, therefore, FIG. 3 sets forth a block diagram of automated computing machinery comprising an example of a database feed adapter (208) useful in interactively streaming data from a database in a high speed, low latency data communications environment according to embodiments of the present invention. The database feed adapter (208) of FIG. 3 includes at least one computer processor (156) or ‘CPU’ as well as random access memory (168) (‘RAM’) which is connected through a high speed memory bus (166) and bus adapter (158) to processor (156) and to other components of the database feed adapter.

Stored in RAM (168) are a conversion module (220), a converter table (222), converter functions (224), application messages (241), message model (244), a messaging middleware (276), and a transport engine (278). Each application message (240) is a quantity of data that includes one or more data fields and is transmitted from one device to another on a message stream. Application messages arc typically created and processed by applications operating in application layers above the network and transport layers of a network protocol stack. As mentioned above, an application message may represent numeric or textual information, images, encrypted information, computer program instructions, and so on. In the example of FIG. 3, the application messages (241) represent historical data converted from a database format to a streaming message format. In a financial market data environment, for example, the application messages (241) may represent historical financial market data such as, for example, financial quotes or financial news. Each application message (241) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art.

In the example of FIG. 3, the converter table (222) is a table that includes references to converter functions (224) capable of converting data from one format to another format and capable of converting request parameters of a request for a message stream of historical data from a subscribing client device into a database query. The conversion module (220), the converter functions (224), the messaging middleware (276), and the transport engine (278) illustrated in FIG. 3 are software components, that is computer program instructions, that operate as described above with reference to FIG. 2.

Also stored in RAM (168) is an operating system (154). Operating systems useful in database feed adapters according to embodiments of the present invention include UNIX™, Linux™, Microsoft NT™, IBM's AIX™, IBM's i5/OS™, and others as will occur to those of skill in the art. The operating system (154), the conversion module (220), the converter table (222), the converter functions (224), the messages (241), the message model (244), the messaging middleware (276), and the transport engine (278) in the example of FIG. 3 are shown in RAM (168), but many components of such software typically are stored in non-volatile memory also, for example, on a disk drive (170).

The exemplary database feed adapter (208) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful in database feed adapters useful according to embodiments of the present invention include the Intel Northbridge, the Intel Memory Controller Hub, the Intel Southbridge, and the Intel I/O Controller Hub. Examples of expansion buses useful in database feed adapters useful according to embodiments of the present invention may include Peripheral Component Interconnect (‘PCI’) buses and PCI Express (‘PCIe’) buses.

The exemplary database feed adapter (208) of FIG. 3 also includes disk drive adapter (172) coupled through expansion bus (160) and bus adapter (I 58) to processor (156) and other components of the exemplary database feed adapter (208). Disk drive adapter (172) connects non-volatile data storage to the exemplary database feed adapter (208) in the form of disk drive (170). Disk drive adapters useful in database feed adapters include Integrated Drive Electronics (‘IDE’) adapters, Small Computer System Interface (‘SCSI’) adapters, and others as will occur to those of skill in the art. In addition, non-volatile computer memory may be implemented for a database feed adapter as an optical disk drive, electrically erasable programmable read-only memory (so-called ‘EEPROM’ or ‘Flash’ memory), RAM drives, and so on, as will occur to those of skill in the art.

The exemplary database feed adapter (208) of FIG. 3 includes one or more input/output (‘I/O’) adapters (178). I/O adapters in database feed adapters implement user-oriented input/output through, for example, software drivers and computer hardware for controlling output to display devices such as computer display screens, as well as user input from user input devices (181) such as keyboards and mice. The exemplary database feed adapter (208) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary database feed adapter (208) of FIG. 3 includes a communications adapter (167) for data communications with other computers (182) and for data communications with a high speed, low latency data communications network (200). Such data communications may be carried out serially through RS-232 connections, through external buses such as a Universal Serial Bus (‘USSB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for interactively streaming data from a database in a high speed, low latency data communications environment according to embodiments of the present invention include modems for wired dial-up communications, IEEE 802.3 Ethernet adapters for wired data communications network communications, and IEEE 802.11b adapters for wireless data communications network communications.

Although FIG. 3 is discussed with reference to exemplary database feed adapters, readers will note that automated computing machinery comprising exemplary stream administration servers and exemplary subscribing client devices useful in interactively streaming data from a database in a high speed, low latency data communications environment according to embodiments of the present invention are similar to the exemplary database feed adapter (208) of FIG. 3. That is, such exemplary stream administration servers and feed adapters include one or more processors, bus adapters, buses, RAM, video adapters, communications adapters, I/O adapters, disk drive adapters, and other components similar to the exemplary database feed adapter (208) of FIG. 3 as will occur to those of skill in the art.

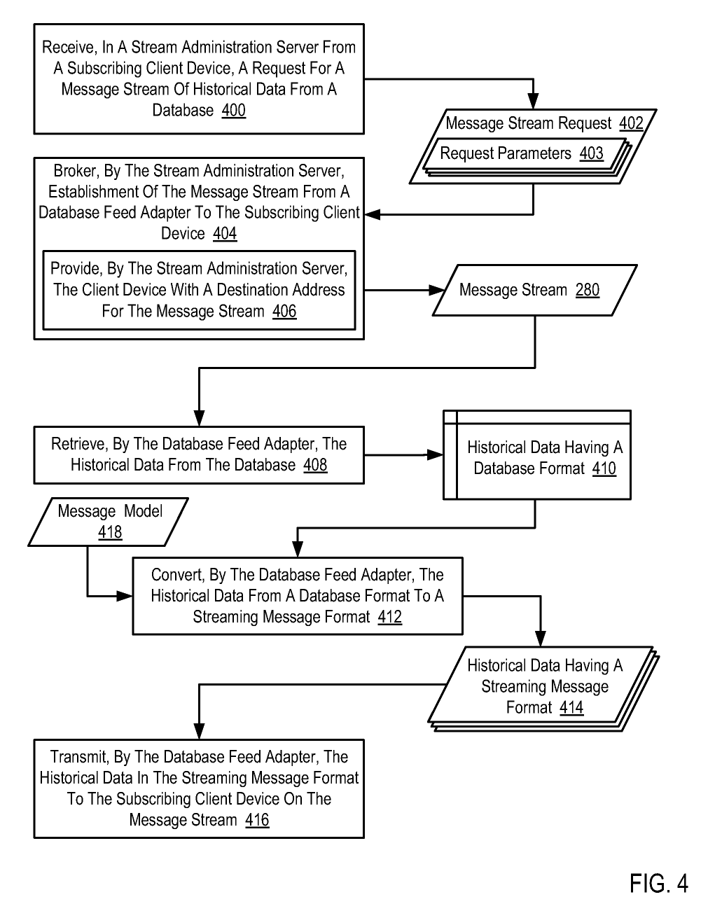

For further explanation, FIG. 4 sets forth a flow chart illustrating an exemplary method for interactively streaming data from a database in a high speed, low latency data communications environment according to embodiments of the present invention. The method of FIG. 4 includes receiving (400), in a stream administration server from a subscribing client device, a request (402) for a message stream of historical data from a database. The request (402) of FIG. 4 for a message stream of historical data from a database may be implemented as an XML document, a call to a member method of a RMI object on the subscribing client device, or any other implementation as will occur to those of skill in the art. In the example of FIG. 4, the request (402) for a message stream includes one or more request parameters (403). The request parameters (403) specify characteristics of the application messages that the subscribing client device requests to receive from the database feed adapter. Each request parameter (403) of FIG. 4 is characterized by a parameter name, a parameter value, and a parameter operator.

For an example of a request (402) for a message stream that includes one or more request parameters (403), consider a financial market data environment in which the request parameters are used to specify the topic of the ticks that a subscribing client device requests to receive from the database feed adapter. In such an example, a topic may specify tick characteristics such as the feed source that provided the tick, the context of the tick, and the product contained in the tick. In a financial market data environment, the feed source aggregates financial market data for various financial exchanges and provides the financial market data in the form of a tick to a feed adapter. The context is the number of bids and asks for the quote contained in a tick. Depending on the value specified for the context of a tick, the tick may include the best bid and best ask for a security for a particular financial market exchange or a set of all the bids and all the asks for a security for a particular financial exchange that trades the security. The product specifies the security and the financial market exchange of the quote contained in the tick. A request (402) used to specify ticks from an OPRA feed source that contains quotes of the numerous IBM options traded on the Chicago Board Options Exchange (‘CBOE’) and that includes the best bid and best ask for the IBM options on the CBOE may include the following exemplary request:
destinationAddress streamAdmin.RequcstHistory(FEED=‘OPRA’, CONTEXT=‘TOP’, SYMBOL BEGINS_WITH ‘IBM’, START_DATE=‘01/01/2000’, END_DATE=‘01/01/2005’);

The exemplary request for a message stream of historical data from a database described above is implemented as the ‘RequestHistory’ method of the ‘streamAdmin’ Java RMI object on the subscribing client device that is a remote procedure object interface for a Java RMI object on the stream administration server. The exemplary request above includes five request parameters. The first request parameter is characterized by the parameter name ‘FEED,’ the parameter value ‘OPRA,’ and a parameter operator ‘=.’ The first request parameter specifies ticks produced from an OPRA feed source. The second request parameter is characterized by the parameter name ‘CONTEXT,’ the parameter value ‘TOP,’ and a parameter operator ‘=.’ The second request parameter specifics ticks containing the best bid and best ask for a security. The third request parameter is characterized by the parameter name ‘SYMBOL,’ the parameter value ‘IBM,’ and a parameter operator ‘BEGINS_WITH.’ The third request parameter specifies ticks having a symbol that begins with the letters ‘IBM.’ The fourth request parameter is characterized by the parameter name ‘START_DATE,’ the parameter value ‘11/01/2000,’ and a parameter operator ‘=.’ The fourth request parameter specifies ticks created on or after Jan. 1, 2000. The fifth request parameter is characterized by the parameter name ‘END_DATE,’ the parameter value ‘01/01/2005,’ and a parameter operator ‘=.’ The fifth request parameter specifies ticks created on or before Jan. 1, 2005.

In the exemplary request for a message stream of historical data from a database described above, the ‘RequestHistory’ method returns a destination address that is stored in the ‘destinationAddress’ variable on the subscribing client device if the request is successful. The destination address may be implemented as a multicast address or a unicast address used by the subscribing client device to listen for application messages from a database feed adapter. Readers will note that the exemplary request for a message stream of historical data from a database above is for explanation and not for limitation. A parameter name of a request parameter may be implemented using numeric or textual information. A parameter operator of a request parameter may be implemented using mathematical operators such as, for example, ‘=’, ‘<’, ‘>’, and ‘≠’. A parameter operator of a request parameter may be implemented using more complex operators such as, for example, ‘BEGINS_WITH,’ ‘CONTAINS,’ and ‘DOES_NOT_CONTAIN.’

The method of FIG. 4 also includes brokering (404), by the stream administration server, establishment of the message stream (280) from a database feed adapter to the subscribing client device. The message stream (280) represents a data communication channel between a communications endpoint of a subscribing client device and a communications endpoint of a database feed adapter. A message stream may be implemented as a multicast data communication channel using the UDP/IP protocols or a unicast data communication channel using TCP/IP protocols as discussed above with reference to FIG. 2.

In the method of FIG. 4, brokering (404), by the stream administration server, establishment of the message stream (280) from a database feed adapter to the subscribing client device may be carried out by providing to the database feed adapter the request (402) for a message stream of historical data from a database. Providing to the database feed adapter the request (402) for a message stream of historical data from a database may be carried out by calling a function of a feed adapter library installed on the stream administration server using the request (402) as an argument, sending the request (402) to the database feed adapter using web services, or any other implementation of providing the database feed adapter with the request (402) as will occur to those of skill in the art.

In the method of FIG. 4, brokering (404), by the stream administration server, establishment of the message stream (280) from a database feed adapter to the subscribing client device includes providing (406), by the stream administration server, the client device with a destination address for the message stream (280). The destination address for the message stream (280) is a multicast address or a unicast address used by the subscribing client device to listen for messages from a feed adapter. The stream administration server may provide the destination address for the message stream (280) to the subscribing client device as a return value from the function used by the subscribing client device to request a message stream of historical data from a database as described above. Using the destination address provided by the stream administration server, the subscribing client device may establish the message stream (280) from the feed adapter to the subscribing client device.

Before the stream administration server provides the request (402) to the database feed adapter and provides the destination address for the message stream (280), the stream administration server in the example of FIG. 4 may perform several security services to ensure that the subscribing client device is authorized to receives the messages specified in the request from the database feed adapter. In the method of FIG. 4, brokering (404), by the stream administration server, establishment of the message stream (280) from a database feed adapter to the subscribing client device may also include authenticating the subscribing client device and authorizing the subscribing client device to receive messages from the database feed adapter on the message stream (280). Authenticating the subscribing client device may be carried out by verifying client security credentials provided by the subscribing client device with the subscription request. The client security credentials may be implemented as a digital signature in a public key infrastructure, a security token, or any other security data as will occur to those of skill in the art for authenticating the identity of the originator of the subscription request. Authorizing the subscribing client device to receive messages from the database feed adapter on the message stream (280) may be carried out by identifying the privileges associated with the authenticated subscribing client device in dependence upon an authorization policy. An authorization policy is a set of rules governing the privileges of authenticated subscribing client devices requesting to receive data from a feed adapter.

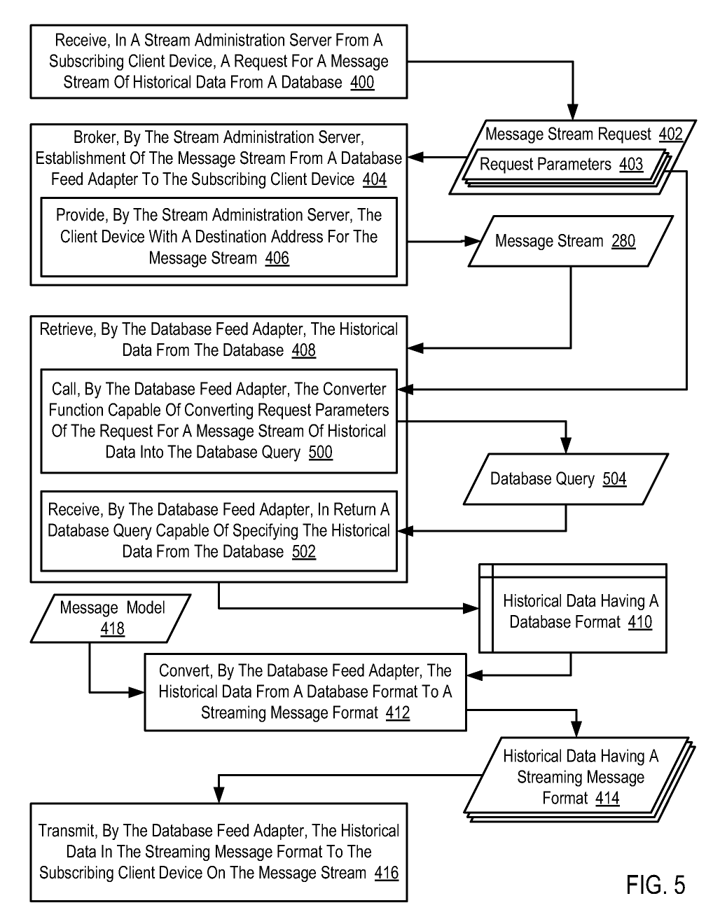

The method of FIG. 4 also includes retrieving (408), by the database feed adapter, the historical data (410) from the database. The historical data (410) of FIG. 4 represents historical data from the database having a database format. That is, the historical data (410) of FIG. 4 represents historical data formatted in tables with records having one or more fields. Retrieving (408), by the database feed adapter, the historical data (410) from the database according to the method of FIG. 4 may be carried out by calling, by the database feed adapter, the converter function capable of converting request parameters of the request for a message stream of historical data into the database query, and receiving, by the database feed adapter, in return a database query capable of specifying the historical data from the database as discussed below with reference to FIG. 5.

The method of FIG. 4 also includes converting (412), by the database feed adapter, the historical data from a database format to a streaming message format. The example of FIG. 4 includes historical data (414) having a streaming message format. The historical data (414) of FIG. 4 represents historical data formatted as application messages for transmission to a subscribing client device. Converting (412), by the database feed adapter, the historical data from a database format to a streaming message format according to the example of FIG. 4 may be carried out by identifying a streaming message format into which the historical data (410) having a database format is to be convened using a message model (418). As mentioned above, the message model (418) represents metadata that defines the structure and the format of the messages for transmission to the subscribing client device. In the example of FIG. 4, converting (412), by the database feed adapter, the historical data from a database format to a streaming message format may further be carried out by calling converter functions of the feed adapter capable of converting the historical data (410) having a database format into historical data (414) having a stream message format specified in the message model (418).

The method of FIG. 4 also includes transmitting (416), by the database feed adapter, the historical data in the streaming message format to the subscribing client device on the message stream. Transmitting (416), by the database feed adapter, the historical data in the streaming message format to the subscribing client device on the message stream according to the method of FIG. 4 may be carried out by encapsulating the historical data (414) having a streaming message format into transport packets recognized by computer software operating in the transport layer of a network protocol stack. Transmitting (416), by the database feed adapter, the historical data in the streaming message format to the subscribing client device on the message stream according to the method of FIG. 4 may further be carried out by transmitting the transport packets to the subscribing client device on the message stream (280) according to the TCP/IP protocols, the UDP/IP protocols, or any other data communication protocols as will occur to those of skill in the art.

As mentioned above, retrieving, by the database feed adapter, the historical data from the database may be carried out by calling, by the database feed adapter, the converter function capable of converting request parameters of the request for a message stream of historical data into the database query, and receiving, by the database feed adapter, in return a database query capable of specifying the historical data from the database. For farther explanation therefore, FIG. 5 sets forth a flow chart illustrating a further exemplary method for interactively streaming data from a database in a high speed, low latency data communications environment according to embodiments of the present invention that includes calling (500), by the database feed adapter, the converter function capable of converting request parameters of the request (402) for a message stream of historical data into the database query, and receiving (502), by the database feed adapter, in return a database query (504) capable of specifying the historical data from the database.

The method of FIG. 5 is similar to the method of FIG. 4 in that the method of FIG. 5 includes receiving (400), in a stream administration server from a subscribing client device, a request (402) for a message stream of historical data from a database, brokering (404), by the stream administration server, establishment of the message stream (280) from a database feed adapter to the subscribing client device, providing (406), by the stream administration server, the client device with a destination address for the message stream (280), retrieving (408), by the database feed adapter, the historical data (410) from the database, converting (412), by the database feed adapter, the historical data from a database format to a streaming message format, and transmitting (416), by the database feed adapter, the historical data in the streaming message format to the subscribing client device on the message stream. The example of FIG. 5 is similar to the example of FIG. 4 in that the example of FIG. 5 includes message stream request (402) that includes one or more request parameters (403), message stream (280), historical data (410) having a database format (410), the message model (418), and historical data (414) having a streaming message format (414).

In the example of FIG. 5, the database feed adapter includes a converter table. Readers will recall from above that a converter table is a table that includes references to converter functions capable of converting data from one format to another format and capable of converting request parameters of a request for a message stream of historical data from a subscribing client device into a database query. The converter table may be implemented using a structured document such as, for example, an eXtensible Markup Language (‘XML’) document.

In the example of FIG. 5, retrieving (408), by the database feed adapter, the historical data (410) from the database includes calling (500), by the database feed adapter, the converter function capable of converting request parameters of the request (402) for a message stream of historical data into the database query and receiving (502), by the database feed adapter, in return a database query (504) capable of specifying the historical data from the database. A converter function capable of converting request parameters of the request (402) for a message stream of historical data into the database query may include the following exemplary converter function:
SQL_Query converterFunctions.RequestParameters2SQL(FEED=‘OPRA’, CONTEXT ‘TOP’, SYMBOL BEGINS_WITH ‘IBM’, START_DATE=‘01/01/2000’, END_DATE=‘01/01/2005’);

The exemplary converter function capable of converting request parameters of the request (402) for a message stream of historical data into the database query described above is implemented as the ‘RequestParameters2SQL’ method of the ‘converterFunctions’ object on the database feed adapter. The exemplary request above includes the same five request parameters of the exemplary request for a message stream of historical data from a database discussed above with reference to FIG. 4. Readers will note that the exemplary converter function capable of converting request parameters of the request (402) for a message stream of historical data into the database query described above is for explanation and not for limitation. Other converter functions capable of converting request parameters of a request for a message stream of historical data into the database query as will occur to those of skill in the art may also be useful according to embodiments of the present invention.

In the exemplary converter function described above, the ‘RequestParameters2SQL’ method returns a database query (504) capable of specifying the historical data from the database if the conversion of the request parameters is successful. The ‘RequestParameters2SQL’ method stores the database query (504) in the ‘SQLQuery’ variable on the database feed adapter. A database query (504) is a specification of a result to be calculated from a database typically by a database management system. A database query is typically specified using ANSI SQL or one of its extensions. A database query (504) returned from the exemplary ‘RequestParameters2SQL’ method described above may include the follow exemplary database query:
select * from HISTORY where FEED=‘OPRA’ and CONTEXT=‘TOP’ and SYMBOL begins with ‘IBM’ and DATE between ‘01/01/2000’ and ‘01/01/2005’;

The exemplary database query described above specifies a return result of all the rows in the ‘HISTORY’ table of the database that satisfy the criteria in the clause beginning with ‘where.’ That is, exemplary database query described above may be used to retrieve all the rows in the ‘HISTORY’ table where the ‘FEED’ field equals ‘OPRA,’ the ‘CONTEXT’ field equals ‘TOP,’ and the ‘SYMBOL’ field contains a value that begins with ‘IBM,’ and the ‘DATE’ field contains a value between ‘01/01/2000’ and ‘01/01/2005.’

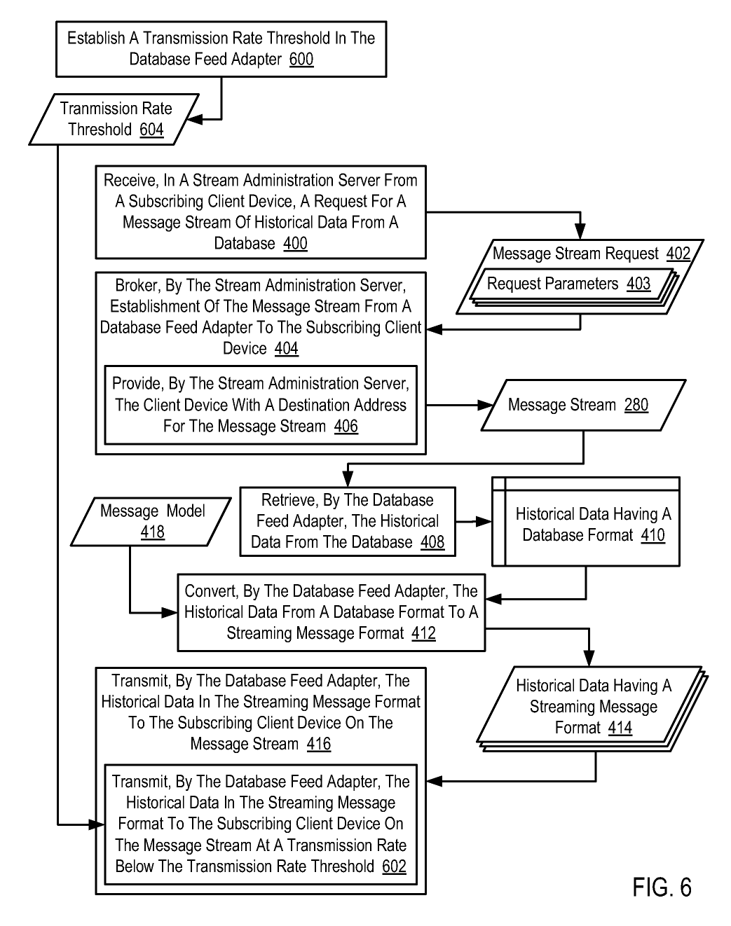

As mentioned above, the application messages transmitted from a database feed adapter to a subscribing client device contain historical data stored in a database—as contrasted with real-time data that arrives at a subscribing client device from a the original data provider without the delays associated with storing and retrieving the data in a database. In a high speed, low latency data communication environment, limiting the network resources for the transmission of historical data is often preferred in an effort to increase the network resources available for transmission of real-time data. To reduce the network resources consumed by transmission of historical data, the database feed adapter may be configured to transmit the historical data at a transmission rate lower than the other feed adapters that transmit real-time data to subscribing client device. For further explanation, therefore, FIG. 6 sets forth a flow chart illustrating a further exemplary method for interactively streaming data from a database in a high speed, low latency data communications environment according to embodiments of the present invention that includes establishing (600) a transmission rate threshold (604) in the database feed adapter.

The transmission rate threshold (604) of FIG. 6 represents a threshold value specifying the maximum transmission rate at which a database feed adapter may transmit the historical data (414) having a streaming message format to a subscribing client device. The transmission rate threshold (604) of FIG. 6 may specify the maximum transmission rate in terms of a maximum quantity of data for transmission over a period of time. For example, transmission rate threshold (604) of FIG. 6 may specify a maximum number of transport packets transmitted over a time period, a maximum number of bytes of data transmitted over a time period, and a maximum number of application messages transmitted over a time period. Although FIG. 6 depicts only a single transmission rate threshold (604), such a depiction is for explanation and not for limitation. In fact, a database feed adapter may utilize multiple transmission rate thresholds. For example, the stream administration server may authorize each subscribing client device to receive the historical data (414) using different transmission rate thresholds.

In the method of FIG. 6, establishing (600) a transmission rate threshold (604) in the database feed adapter may be carried out by configuring, by a system administrator, the database feed adapter with preset value for the transmission rate threshold (604). Establishing (600) a transmission rate threshold (604) in the database feed adapter according to the method of FIG. 6 may also be carried out by dynamically configuring, by the stream administration server, a value for the transmission rate threshold (604) in dependence upon the message streams already established in the high speed, low latency data communication environment. If message streams already established are consuming large amounts of network resources, the stream administration server may set a transmission rate threshold (604) in the database feed adapter lower than when the message streams already established are consuming small amounts of network resources.

The method of FIG. 6 is similar to the method of FIG. 4 in that the method of FIG. 6 includes receiving (400), in a stream administration server from a subscribing client device, a request (402) for a message stream of historical data from a database, brokering (404), by the stream administration server, establishment of the message stream (280) from a database feed adapter to the subscribing client device, providing (406), by the stream administration server, the client device with a destination address for the message stream (280), retrieving (408), by the database feed adapter, the historical data (410) from the database, converting (412), by the database feed adapter, the historical data from a database format to a streaming message format, and transmitting (416), by the database feed adapter, the historical data in the streaming message format to the subscribing client device on the message stream (280). The example of FIG. 6 is similar to the example of FIG. 4 in that the example of FIG. 6 includes message stream request (402) that includes one or more request parameters (403), message stream (280), historical data (410) having a database format (410), the message model (418), and historical data (414) having a streaming message format (414).

In the method of FIG. 6, transmitting (416), by the database feed adapter, the historical data in the streaming message format to the subscribing client device on the message stream (280) includes transmitting (602), by the database feed adapter, the historical data in the streaming message format to the subscribing client device on the message stream at a transmission rate below the transmission rate threshold (604). Transmitting (602), by the database feed adapter, the historical data in the streaming message format to the subscribing client device on the message stream at a transmission rate below the transmission rate threshold (604) may be carried by repeatedly transmitting only the quantity of historical data (414) specified in the transmission rate threshold (604) over the time period specified in the transmission rate threshold (604) and pausing transmission of the historical data (414) if the time period has not elapsed by the time the quantity of data specified in the threshold (604) has been transmitted. Consider, for example, a transmission rate threshold of 1,000 transport packets per second. The database feed adapter may transmit 1,000 transport packets containing historical data having a streaming message format and then pause transmission if one second has not elapsed since the beginning of the transmission of the 1,000 transport packets. After the one second has elapsed, the database feed adapter may transmit the next 1,000 transport packets and then pause if one second has not elapsed since the beginning of the transmission of the next 1,000 transport packets.

In view of the explanations set forth above in this document, readers will recognize that practicing interactively streaming data from a database in a high speed, low latency data communications environment to embodiments of the present invention provides the following benefits:
subscribing client devices need only recognize one data format—a streaming message format—instead of two data formats—a streaming message format and a database format,
historical data may be provided in a high speed, low latency data communications environment while giving network resource priority to the transmission of real-time data, and
message data providers may use the same framework that provides access to their real-time data to provide access to their historical data as well.

Exemplary embodiments of the present invention are described largely in the context of a fully functional computer system for interactively streaming data from a database in a high speed, low latency data communications environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of interactively streaming data from a database in a high speed, low latency data communications environment, the method comprising:
receiving, in a stream administration server from a subscribing client device, a request for a message stream of historical data from a database;
brokering, by the stream administration server, establishment of the message stream from a database feed adapter to the subscribing client device;
retrieving, by the database feed adapter, the historical data from the database;
converting, by the database feed adapter, the historical data from a database format to a streaming message format; and
transmitting, by the database feed adapter, the historical data in the streaming message format to the subscribing client device on the message stream.

2. The method of claim 1 wherein the high speed, low latency data communications environment comprises a high speed, low latency data communications network, the network further comprising the database feed adapter, the stream administration server, at least one subscribing client device, and no router.

3. The method of claim 1 wherein the request for a message stream comprises one or more request parameters, each request parameter characterized by a parameter name, a parameter value, and a parameter operator.

4. The method of claim 1 wherein:
the database feed adapter comprises a converter table, the converter table comprising references to converter functions, including at least one converter function capable of converting request parameters of the request for a message stream of historical data into a database query; and
retrieving, by the database feed adapter, the historical data from the database further comprises:
calling, by the database feed adapter, the converter function capable of converting request parameters of the request for a message stream of historical data into the database query, and
receiving, by the database feed adapter, in return a database query capable of specifying the historical data from the database.

5. The method of claim 1 wherein brokering, by the stream administration server, establishment of the message stream from the database feed adapter to the subscribing client device further comprises providing, by the stream administration server, the client device with a destination address for the message stream.

6. The method of claim 1 further comprising:
establishing a transmission rate threshold in the database feed adapter,
wherein transmitting, by the database feed adapter, the historical data in the streaming message format to the subscribing client device on the message stream further comprises transmitting, by the database feed adapter, the historical data in the streaming message format to the subscribing client device on the message stream at a transmission rate below the transmission rate threshold.

7. The method of claim 1 wherein:
the historical data is historical application message data; and
the database is an application message history database.

8. Apparatus for interactively streaming data from a database in a high speed, low latency data communications environment, the apparatus comprising one or more computer processors, one or more computer memories operatively coupled to the one or more computer processors, the computer memories having disposed within them computer program instructions capable of:
receiving, in a stream administration server from a subscribing client device, a request for a message stream of historical data from a database;
brokering, by the stream administration server, establishment of the message stream from a database feed adapter to the subscribing client device;
retrieving, by the database feed adapter, the historical data from the database;
converting, by the database feed adapter, the historical data from a database format to a streaming message format; and
transmitting, by the database feed adapter, the historical data in the streaming message format to the subscribing client device on the message stream.

9. The apparatus of claim 8 wherein the high speed, low latency data communications environment comprises a high speed, low latency data communications network, the network further comprising the database feed adapter, the stream administration server, at least one subscribing client device, and no router.

10. The apparatus of claim 8 wherein the request for a message stream comprises one or more request parameters, each request parameter characterized by a parameter name, a parameter value, and a parameter operator.

11. The apparatus of claim 8 wherein:
the database feed adapter comprises a converter table, the converter table comprising references to converter functions, including at least one converter function capable of converting request parameters of the request for a message stream of historical data into a database query; and
retrieving, by the database feed adapter, the historical data from the database further comprises:
calling, by the database feed adapter, the converter function capable of converting request parameters of the request for a message stream of historical data into the database query, and
receiving, by the database feed adapter, in return a database query capable of specifying the historical data from the database.

12. The apparatus of claim 8 further comprising computer program instructions capable of:
establishing a transmission rate threshold in the database feed adapter,
wherein transmitting, by the database feed adapter, the historical data in the streaming message format to the subscribing client device on the message stream further comprises transmitting, by the database feed adapter, the historical data in the streaming message format to the subscribing client device on the message stream at a transmission rate below the transmission rate threshold.

13. A computer program product for interactively streaming data from a database in a high speed, low latency data communications environment, the computer program product disposed upon a signal bearing medium, the computer program product comprising computer program instructions capable of:
receiving, in a stream administration server from a subscribing client device, a request for a message stream of historical data from a database;
brokering, by the stream administration server, establishment of the message stream from a database feed adapter to the subscribing client device;
retrieving, by the database feed adapter, the historical data from the database;
converting, by the database feed adapter, the historical data from a database format to a streaming message format; and
transmitting, by the database feed adapter, the historical data in the streaming message format to the subscribing client device on the message stream.

14. The computer program product of claim 13 wherein the signal bearing medium comprises a recordable medium.

15. The computer program product of claim 13 wherein the signal bearing medium comprises a transmission medium.

16. The computer program product of claim 13 wherein the high speed, low latency data communications environment comprises a high speed, low latency data communications network, the network further comprising the database feed adapter, the stream administration server, at least one subscribing client device, and no router.

17. The computer program product of claim 13 wherein the request for a message stream comprises one or more request parameters, each request parameter characterized by a parameter name, a parameter value, and a parameter operator.

18. The computer program product of claim 13 wherein:
the database feed adapter comprises a converter table, the converter table comprising references to converter functions, including at least one converter function capable of converting request parameters of the request for a message stream of historical data into a database query; and
retrieving, by the database feed adapter, the historical data from the database further comprises:
calling, by the database feed adapter, the converter function capable of converting request parameters of the request for a message stream of historical data into the database query, and
receiving, by the database feed adapter, in return a database query capable of specifying the historical data from the database.

19. The computer program product of claim 13 wherein brokering, by the stream administration server, establishment of the message stream from the database feed adapter to the subscribing client device further comprises providing, by the stream administration server, the client device with a destination address for the message stream.

20. The computer program product of claim 13 further comprising computer program instructions capable of:
establishing a transmission rate threshold in the database feed adapter,
wherein transmitting, by the database feed adapter, the historical data in the streaming message format to the subscribing client device on the message stream further comprises transmitting, by the database feed adapter, the historical data in the streaming message format to the subscribing client device on the message stream at a transmission rate below the transmission rate threshold.
